(19) United States
(12) Patent Application Publication
(10) Pub. No.: US 2024/0037488 A1
(43) Pub. Date: Feb. 1, 2024

(54) MATCHMAKING CARRIER SERVICES SYSTEM AND METHOD

(71) Applicant: XtayPro Canada Inc., Oshawa (CA)

(72) Inventors: Trung Hieu Nguyen, Oshawa (CA); Thi Anh Tu Nguyen, Oshawa (CA); Si Trieu Chau Nguyen, Oshawa (CA); Nhat Quang Hang, Oshawa (CA)

(21) Appl. No.: 18/359,811

(22) Filed: Jul. 26, 2023

Related U.S. Application Data
(60) Provisional application No. 63/392,478, filed on Jul. 26, 2022.

(51) Int. Cl. G06Q 10/0831; G06Q 20/10; G06Q 50/00; G06Q 30/0601; G06Q 30/0282; G06F 40/58

(52) U.S. Cl. CPC G06Q 10/0831; G06Q 20/108; G06Q 50/01; G06Q 30/0611; G06Q 30/0282; G06F 40/58

(57) ABSTRACT

A matching making carrier service system and method that enables users to connect and collaborate on carrier services is described. The system provides a platform for users to search for each other for goods transportation purposes, such that a requester user and a traveler user can agree upon a freelance carrier service. The system may be configured to provide means to verify each user to provide reliable security of transactions between users. The system may be configured to provide escrow services to hold payment in secured means, such that payment may be configured to reliably provided upon completion of tasks. The platform may be configured to provide a feedback and review system such that users can be rated and ranked for the services rendered. The system may be configured to provide security encryption to ensure reliable interaction between users.

### CROSS-REFERENCE TO RELATED APPLICATION

This application claims the benefit of U.S. Provisional Patent Application No. 63/392,478 filed Jul. 26, 2022, and the entire contents of United States Provisional Patent Application No. 63/392,478 are hereby incorporated herein in its entirety.

### BACKGROUND

With countries having their own customs, rules, and laws, it can be overwhelming to handle international travels independently, without the support of a travel agency or expensive travel service. Furthermore, if there are purchases or transaction of goods involved with the travel, it can bring another level of complexities that would deter potential travelers. Accordingly, there may be users who are looking for ways to send the goods without having to travel themselves.

### SUMMARY

In one aspect, in accordance with the teachings herein there is provided a system for assisting users to arrange cross-border item delivery utilizing a peer to peer matchmaking platform, which is an online platform. The system is adapted to match travelers and requesters based on electronic data provided to the online platform. For example, with this platform, electronic data such as preferences, ratings, user rank, etc. are gathered and obtained which may be used by users to transact with one another for the provision of travelling with one or more good to bring the goods to a desired location.

In at least one embodiment, the system, via an input means provided by the platform such as a GUI for example, lets travelers post electronic data on the platform for their upcoming trips, with information/parameters such as type of travel, departure location/time, destination, date of travel, date of fulfillment, and/or preferred payment method.

In at least one embodiment, the system lets requesters post their electronic requests on the platform with specific information/parameters such as type of goods, shipping locations, commercial websites, desired date of receipt, and delivery address. These can be in relation to a travel plan.

In at least one embodiment, the system may be configured to provide an electronic “Know Your Customer” feature (eKYC) where users can request verification. User rank is upgraded using automated services such as email verification, phone number verification, bank account verification, and ID verification.

In at least one embodiment, the system may be configured to provide an escrow service where users make payments via the platform to ensure the authentication and success of transactions. For example, in at least one embodiment, the system may be configured to provide an auto translation service for users from different countries speaking different languages.

In at least one embodiment, the system enables multiple-user transactions for the cases where third parties are involved. This may be done by configuring the system to provide one or more specific application program interfaces (APIs) to link databases and processes with those provided by third-parties such as, but not limited to, payment gateways, customs declarations, tax collection etc.

In at least one embodiment, the system may be configured to use the latest architecture and frameworks to provide sophisticated obfuscation for preventing reverse engineering and hacking. In addition, in at least one embodiment, the system may be configured to use the latest encryption technologies to protect all connection through frequently renewed tokens.

In one aspect, in accordance with the teachings herein, there is provided at least one embodiment of a matchmaking carrier service system, comprising: at least one server that is configured to provide a platform that is adapted to receive data from at least one user through at least one user interface so that the at least one user can connect with at least one other user to arrange an agreement for carrier service between at least two locations; and communication hardware that is communicatively coupled to the at least one server to receive and send data to at least one personal device used by the at least one user to access the platform.

In at least one embodiment, the at least one user interface includes an automated translation service.

In at least one embodiment, the at least one user is a requester user.

In at least one embodiment, the at least one user is a traveler user.

In at least one embodiment, the carrier service is arranged between at least two users.

In at least one embodiment, the at least one server includes a remote server or a cloud server.

In at least one embodiment, the server is adapted to provide an escrow service for payment upon completion of the agreement.

In another aspect, in accordance with the teachings herein, there is provided at least one embodiment of a method to provide an online platform for carrier services through peer to peer matchmaking, comprising: receiving, at a server, data from users for creating user profiles on the online platform where the data is received through at least one user interface; verifying user profiles through secure methods and frameworks; posting requests and travel plans on the online platform based on information received from users; and connecting at least one request user with at least one traveler user to facilitate the arrangement of at least one carrier service between the users.

In at least one embodiment, the method comprises providing a ranking score for a given user based on information provided about the given user and a history of carrier services completed that involve the given user.

In at least one embodiment, the method comprises receiving review scores from users for the other users.

In at least one embodiment, the method comprises securing payment for the carrier service in an escrow, wherein the payment is dispersed to the users upon completion of the carrier service.

In at least one embodiment, connecting the users further comprises utilizing encryption technologies.

In another aspect, in accordance with the teachings herein, there is provided at least one embodiment of a non-transitory computer readable medium storing thereon program instructions, which when executed by at least one processor, configure the at least one processor for performing a method for providing an online platform for carrier services through peer to peer matchmaking, wherein the method is defined according to the teachings herein.

It will be appreciated that the foregoing summary sets out representative aspects of embodiments to assist skilled readers in understanding the following detailed description. These and other features and advantages of the present application will be apparent from a reading of the following detailed description and a review of the appended drawings. It is to be understood that the foregoing summary, the following detailed description, the appended drawings and the specific examples, while indicated embodiments of the application, are explanatory only and given by way of illustration only and are not restrictive of various aspects claimed herein since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is block diagram of an example embodiment of a matchmaking carrier services system in accordance with the teachings herein.

FIG. 2 is flow chart diagram of an example embodiment of a process associated with the matchmaking carrier services system.

Further aspects and features of the example embodiments described herein will appear from the following description taken together with the accompanying drawings.

### DETAILED DESCRIPTION

There are many in the world that would appreciate a platform for seasoned international travelers to provide carrier services as part of their travels. Accordingly, there is provided a platform in accordance with the teachings herein that provides a peer-to-peer network of international travelers with the ability to transport appropriate quantity of merchandise on an individual level. The platform provides a new process and electronic technology to facilitate the process of cross-border purchases and to provide fast and reliable delivery services to other e-commerce platforms. Users may use the platform to list requests for the goods to be transported, and other users can advertise their planned trips through which the goods can be transported. This enables collaboration between users for existing and planned trips, so that an effective network of goods exchange can be carried out without relying on external carriers.

The system described herein is adapted to provide a platform that implements the process of cross border purchases in such a way as to provide reliable and fast delivery service to e-commerce platforms. In at least one embodiment, the system may be configured/designed to utilize one or more options such as, but not limited to, eKYC, auto-matching, auto-translation, and escrow services. In at least one embodiment, the system may also be configured to employ open API for third party interactions.

The various system embodiments described herein provide a platform to enable users to arrange shipments and deliveries across international markets. The platform allows for the establishment of a peer to peer delivery network to grant improved control over the international shipping process. The platform will provide a user interface or application programming interface (API) so that users can communicate with one another through their personal electronic devices such as, but not limited to, smart phones, tablets, laptops, and desktop computers, for example. Users will be able to collaborate with other users and provide feedback, thereby creating a rating system that would provide firsthand experience based review for the user community of the platform.

In at least one embodiment system is configured to provide secure connections among users and to improve transactional security over payments and financial information exchanges. An escrow service can be integrated into the platform to ensure payments will only be transferred with the explicit approval of users at the conclusion of the interaction.

Accordingly, the various system embodiments provide a platform for multiple users to plan, arrange, and conduct transactions for a variety of purposes. The present platform is not limited to solely commercial transactions, and in at least one embodiment a platform can be provided by the system to provide a secure channel for personal transactions and other commercial/non-commercial activities.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment”, “an embodiment”, “an example embodiment”, “one implementation”, “an implementation”, “one example”, “an example” and the like, indicate that the described embodiment, implementation or example can include a particular feature, structure or characteristic, but every embodiment, implementation or example may not necessarily include the particular feature, structure or characteristic. Moreover, such phrases may not necessarily refer to the same embodiment, implementation or example. Further, when a particular feature, structure or characteristic is described in connection with an embodiment, implementation or example, it is to be appreciated that such feature, structure or characteristic may be implemented in connection with other embodiments, implementations or examples whether or not explicitly described.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

Similarly, throughout this specification and the appended claims the term “communicative” as in “communicative pathway”, “communicative coupling”, and in variants such as “communicatively coupled” is generally used to refer to any engineered arrangement for transferring and/or exchanging electronic information. Examples of communicative pathways include, but are not limited to, electrically conductive pathways (e.g., electrically conductive wires, physiological signal conduction), electromagnetically radiative pathways (e.g., radio waves, optical signals, etc.), or any combination thereof. Examples of communicative couplings include, but are not limited to, electrical couplings, magnetic couplings, radio couplings, optical couplings or any combination thereof.

A portion of the example embodiments of the systems, devices, or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and/or non-volatile memory). These devices may also have at least one input device (e.g., a keyboard, a mouse, a touchscreen, and the like) and at least one output device (e.g., a display screen, a printer, a wireless radio, and the like) depending on the nature of the device.

It should also be noted that there may be some elements that are used to implement at least part of the embodiments described herein that may be implemented via software that is written in a high-level procedural language such as object-oriented programming. The program code may be written in C, C++ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Any module, unit, component, server, computer, terminal or device described herein that executes software instructions in accordance with the teachings herein may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling with the spirit and scope of the claimed subject matter.

At least one embodiment of a system is described herein where the system is configured to provide a platform to enable the process of cross-border purchases and to provide a fast and reliable delivery service. Accordingly various system embodiments are described that provide a platform that enables peer to peer service for the users, who can search for, evaluate, and arrange merchandise transport and delivery internationally. This interaction and connection can be managed electronically entirely on the platform without requiring a service provider.

Accordingly, the various system embodiments described herein provide an electronic online (e.g., networked) platform allow for a large degree of freedom in creating requests and fulfilment requirement. Each user on the platform will be able to search through a database, that is communicatively coupled to the platform, for a specific type of service (e.g., goods delivery) and travelers needed. Depending on the user's needs, different trips will be better suited for different types of travelers. Therefore, the platform provided by the systems described herein enables a user to arrange services in specific manner without a dedicated third party management. The degree of freedom and access provided is unmatched by current merchandise transportation services.

As a peer to peer service enabling platform, a user can both be the service requestor and a service provider. A user can generate electronic service requests and search for other users who are travelling and can act as a potential service provider. Alternatively, a user can elect to be a service provider when they prepare to go on trips. When a user will be a traveller and advertises a trip electronically on the platform, other users that may like to have goods transported along the same route may then commission the traveler to bring along the goods. This provides an effective peer to peer transportation model, as goods do not require a dedicated carrier to make a separate trip.

In at least one embodiment, the present system utilizes a matchmaking system to allow users to electronically find and retain travelers for transport purposes. IN such embodiments, the system is adapted to run software to match travelers and requesters based on information/parameters provided on the online platform. From this platform, information/parameters such as preferences, ratings, user rank etc. are gathered and obtained electronically. In a preferred embodiment, the system is adapted to provide a user interface that can be accessed through a client software application that is running on the user's personal computer device, which may be a computer, a tablet computer, a mobile phone and the like. The users can use their client software application to electronically communicate with the platform. For example, each user may interact with the platform to set up a number of factors associated with their user profile, so that the user profiles can be used to filter (e.g., search for) desired selections for a user that is searching for a traveler service provider. Accordingly, the filtering and selection of the users may preferably be done so that it is specific to each user's needs, and the user interface provides the function to the user to tailor the search results based on individual preferences (e.g., parameters). In some embodiments, the user preferences can be saved as templates for quicker access. Any data that is saved may be stored on a data store that is accessible by the system that provides the platform.

A user can be a requester or a traveler (e.g., service provider), or both. A requester is a user that would like goods to be transported between locations, or through a particular trip. A traveler would be a user that is traveling on a predetermined trip and would elect to be a potential transporter in the process. As a peer to peer system, users can electronically communicate with one another via their client applications and the platform to form an electronic arrangement (e.g., agreement of provision of services) without the interference or management of a third party agency.

In at least one embodiment, the system is configured to provide functionality on the platform to allow travelers to electronically post about their upcoming trips, and provide information/parameters such as, but not limited to, type of travel, departure location/time, destination, date of travel, date of fulfillment, and/or preferred payment method. Because a traveler may presumably travel for purposes that are not solely for transportation of a particular shipment, these details may provide significant insight for requester users to evaluate the posted trip to determine if it meets their transportation goals. In some embodiments, traveler users can elect to become transport users sole for the purpose of being a carrier. For example, freelance travelers may utilize the platform to create a network of carrier services. In these embodiments, a user can utilize the platform to electronically advertise potential carrier routes, such that more organized transportation schedules can be organized.

In at least one embodiment, the system is adapted to allow requester users to electronically post their requests on the platform with specific information/parameters such as type of goods, shipping locations, commercial web sites, desired date of receipt, and/or delivery address. These parameters can be in relation to the travel plan. A requester user can utilize the platform to search for casual travelers willing to be the carrier for one time transportation purposes. A requester user can also perform searches on the platform for more established traveler users to be a scheduled carrier for certain merchandise. For example, in at least one embodiment, the platform can provide search functions to a requester user that is an established market participant looking to expand goods delivery channels through a peer to peer model, without relying on traditional carrier companies.

Each user will have a user profile with a number of parameters associated to the user profile. In at least one example embodiment, one such parameter may be a rating score. For example, the system may be configured to provide users with an option to electronically assign a rating score to each other at the end of their interaction. For example, a requester user can give a rating score to a traveler user, representing the satisfaction level associated with their delivery performance. Alternatively, as another example, a traveler user can assign a rating score to a requester user, for the ease of collaboration and timeliness of payment issued. These rating scores would be amalgamated into a ranking system/service that is provided on the platform by the system, so that users can form a community based review system. In such embodiments, when a user searches for others for a particular service, they can elect to apply a filter for a minimal rating score required. This may be used to eliminate any unwanted clutter in the search process.

In at least one embodiment, users can electronically interact with the platform to display non-ranking based parameters to expedite the search process. Since the platform provided by the system may be used to assist in international carrier services, users with a preferred payment method (e.g., currency, payment service provider, etc.) may be able to filter out other users in their search results who do not fit into their preferred requirement. Other parameters and factors such as, but not limited to, type of goods, quantity of goods, delivery time period, and/or delivery method, as examples, may be fields in the search filters for which users can provide inputs to perform more targeted searching.

In at least one embodiment, the system may be configured to provide an electronic “Know Your Customer” feature (eKYC) where users can request verification. The eKYC feature is a procedure to identify and verify a customer's identity. In a peer to peer network, being able to verify another user's identity is paramount in ensuring operational security. This process can consist of a series of checks implemented prior to user engagement, aiming to verify a user's identity with a number of required documents and files. For example, the system may integrate or interact with standard eKYC methodology that is currently known in the market currently as well as other versions in the future.

In at least one embodiment, the system can be configured to interact with hardware to obtain scans of identification cards, passports, driver's license, bank statements, or other documents that may be required in each respective country/state for identity verification purposes. In such embodiments, visual eKYC verification methods such as video conference, photo verification, voice verification, and/or facial recognition scans may be incorporated into or used by the system. In at least one embodiment, the degree to which the verification process is performed may be customizable by each user.

In at least one embodiment, the system can be configured to associate the user verification process with user ranks. The user rank can be upgraded using automated services such as email verification, phone number verification, bank account verification, and ID verification. In at least one embodiment, the system may be configured to implement a special display system to highlight the verification status of the verified user, making them standout as preferred collaborators for prospectors.

In at least one embodiment, the system may be configured to provide or interact with another system that provides an escrow service where users make electronic payments via the platform to ensure the authentication and success of electronic commercial transactions. In at least one embodiment, payment may be finalized upon completion of the agreed upon task. In the meantime, before the task is completed, both parties may be able to secure a guarantee of payment through an escrow service through interaction with the electronic platform. For example, in at least one embodiment, the system may be partnered with (i.e., electronically linked to) a financial institute to establish an escrow service, such that payment can be held by the financial institute prior to task completion and approval. In such embodiments, the system may be configured to apply a series of checks to ensure the end users are satisfied with the performance of the task. This may ensure that both the requester user and the traveler user will have confidence in secured exchange upon completion of tasks.

Because the various system embodiments described herein may be configured to provide services to international users, such systems may be designed to operate in languages spoken in each country. For example, in such cases, the system may be configured to provide an auto translation service for users from different countries speaking different languages. Accordingly, in at least one embodiment, a user can interact with the platform to select a source and destination language, and the platform may engage an electronic auto translation service to display output text in the destination language after receiving input text in the source language. The auto translation service may be applied in real time or through a user prompt. The auto translation service can also be applied to request posted in other languages, such that users can elect to display other user messages only in a particular language.

In at least one embodiment, the present system may be configured to facilitate transactions between two or more users. For example, the system may be configured to enable multiple-user transactions for the cases where third parties are involved. In the situation where multiple users are involved in the transportation and transaction of goods exchange, the present system may be able to coordinate the interaction among them. For example, the platform may be configured to provides feature that may be used to connect multiple users for any projects, such that the goods exchanged can take place through multiple stages or dates of travel. The platform may additionally enable users to organize transactions among multiple users through a number of travel trips. For each of these options, the platform can receive inputs provided by the user through a user interface at the user's electronic device that electronically communicates with the platform. Based on these inputs, a multi-user transaction agreement can be electronically created. This provides the flexibility to achieve a user's goal with an elevated level of versatility and control. In addition, the third parties can be third party participants or beneficiaries, where their roles can be defined by one user of the party or an agreed number of participants.

In at least one embodiment, the system may be configured to provide user interfaces that can be accessed through personal electronic devices that are preferred and used by each user. Through these user interfaces, the users can communicate with other users as well as third parties to coordinate the travels. In such embodiments, the system may be configured to use specific application program interfaces (APIs) to link databases and processes with third-parties, such as payment gateways, customs declarations, tax collection, etc. Depending on the requirement of each travel destination, the user interface provided by the platform may be communicatively coupled to accessible hubs, through which users of the platform can electrically contact third parties to arrange for collaborations.

In at least one embodiment, the system is adapted to provide state of the art security measures to ensure the reliability of user interactions. The system may be configured to use the latest architecture and frameworks to provide sophisticated obfuscation for preventing reverse engineering and hacking. For example, a person with ordinary skill in the art may be able to utilize any of the standard frameworks currently in the market to achieve the desired level of security. In at least one embodiment, the architecture that may be used ins Model View ViewMode (MVVM). In at least one embodiment, the system may be configured to utilize frameworks such as Room, Realms, Rx, Daggers, etc. Accordingly, various combinations of frameworks and architectures can be used by the present system embodiments.

In addition, in at least one embodiment, the system may be configured to use the latest encryption technologies to protect all connections (e.g., electronic communications) through frequently renewed tokens. By implementing frequently renewed tokens, such systems can be configured to provide access tokens that are valid for only a short period of time. These tokens can be refreshed with continued verification of user identity. This type of security framework may provide flexible options for users to consistently verify user interaction and provided added reliability based on customized needs. Some examples of encryption technology that may be used include, but are not limited to, bcrypt or rbnacl, for example.

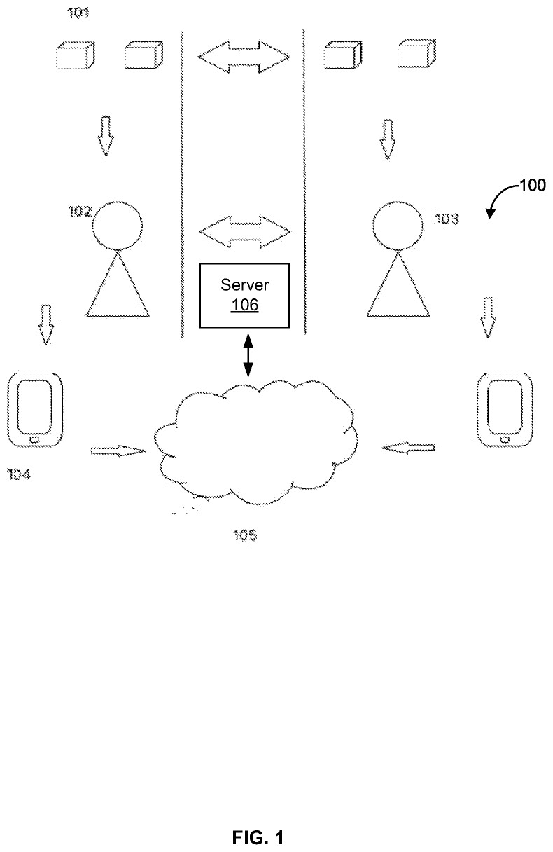

Referring now to FIG. 1, shown therein is a block diagram of an example embodiment of a system 100 in accordance with the teachings herein. The system 100 comprises one or more devices, such as a server 106, that implements a platform and runs process to allow users 102, 103 to electronically communicate with one another when the users 102, 103 use their electronic devices 104 to communicate with the platform in order to arrange for transportation of goods 101 across borders. The goods 101 can be located in any of the locations that users 102 103 would plan to travel to or from. In this example embodiment, user 102 is a requester user and user 103 is a traveler user.

The server 106 includes at least one processor and communication hardware that allows the server 106 to perform certain functions such as providing the electronic platform that the users 102, 103 can interact with via user interfaces and their electronic devices 104. The server 106 includes memory that stores software that, when executed by the processor, configures to processor to operate in certain manners to provide one or more of the functions described herein for the online platform. Accordingly, it should be understood that when the description herein refers to a system being configured to operate in a certain manner, it can be understood that certain software is being executed by the processor to configure the system to operate in a certain way or to provide certain functionality to the platform. It should also be noted that there may be more than one server and more than one processing element which may collectively work together to implement the system functionality. In at least one embodiment, the server is electronically connected to one or more data stores for storing data for the online platform which may include databases. Through software and the communication hardware, the server 106 may communicate with other remote systems that provide certain functions such as an escrow system or an electronic payment system, for example. The server 106 may be provided at a remote location or online via the cloud 105.

User 102 may post an electronic request through their personal device 104 to the server 106, where all personal devices 104 can communicatively connect to. This may be done by running a client software application on the personal devices 104 (e.g., electronic computing devices) which allows the user to interact with a user interface provided by the platform. The request user 102 may announce the need to transports goods 101 to and from two defined locations via the post. The traveler user 103 may view the request on their personal device, through either preset notifications where electronic messages may be delivered to the user's personal device to notify the user of a new electronic post or through a browsing process where the user can browse or search through electronic posts on the platform. The user can then decide if they would participate as a carrier to transport the goods 101. In this example embodiment, the user 103 may electronically contact user 102 and establish an arrangement electronically. The electronic contact may be through sending electronic messages teach others electronic devices through the online platform. Once both users 102 and 103 arrive at an arrangement, the traveler user 103 proceeds to transport the goods 101 through their own travel. A payment may be issued in an escrow by the requester user 102 to be held within a third party via the cloud 105, for example. Upon completion of delivery, the traveler user 103 can collect the payment as previously agreed upon.

Alternatively, the traveler user 103 may advertise their planned trip on the online platform, and the requester user 102 may reach out to solicit goods delivered along the trip. As part of a peer to peer network, both users may act as the requester and service provider, depending on the circumstances.

During the creation of an arrangement, in at least one embodiment the system may be configured to provide a rating and ranking system for the users. Each of requester and traveler users may show up in a search filter, if they both fit the search parameters set forth in an electronic query that is made on the online platform by a requester. In at least one embodiment, the system may be configured such that at the conclusion of the interaction between the requester user 102 and the traveler user 103, both users may be able to provide an electronic feedback review for the other, such that their respective rankings may be updated to reflect the recent review.

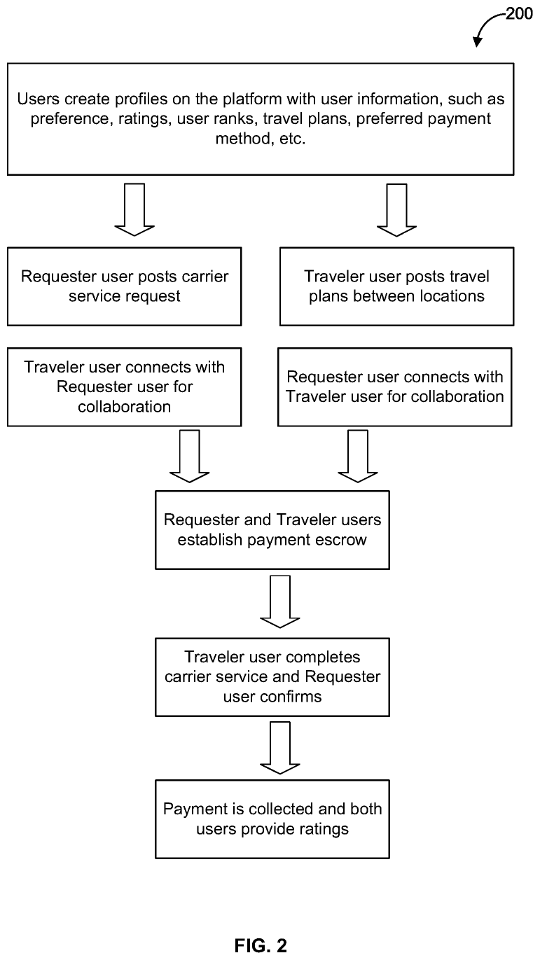

Referring now to FIG. 2, shown therein is a flowchart diagram of an example embodiment a process 200 associated with at least one of the matchmaking carrier service systems described herein. Generally, users create their user profile on the platform through an interface provided by the platform which is accessible on their users' personal devices. Such information may be uploaded to and managed by the server 106 associated with the present system. The user can elect to provide information such as preferences, locations, payment options, and/or mode of travel. The system can assign a rating or ranking score to the user based on previous interactions or information supplied by the users. In at least one embodiment, the users may be verified through the system through a selection of methodologies, including frequently refreshing tokens or eKYC systems. The verification process can be used by the system to modify the rating and ranking score of each user.

As a peer to peer service system, a user can be a requester user, a traveler user, or both. Depending on the nature of the interaction, a user's role can be fluent. In one example scenario, a requester user makes electronic posts on the online platform about goods to be transported between locations. A traveler user can see the electronic post through filtered searches or general browsing that they perform through the user interface, and can elect to reach out and connect with the requester user. This may be done by sending a message to the requester user's device via the online platform, for example.

Alternatively, a traveler user can electronically post their intended travel plan on the online platform. A requester user can find such posts when using their electronic device and the user interface of the online platform when browsing for potential carriers. For example, when a requester user finds a traveler user with a matching travel route, they can reach out to connect with the travel user to initiate collaboration by electronically communicating with the travel user via the online platform as described previously.

In both scenarios, an agreement may be reached by both the requester user and the traveler user. The users can electronically discuss the arrangement through the user interface or through contact information provided therein. For example, in at least one embodiment the system may be configured to provide means to enter the details of the agreement, such that the carrier service arrangement can be recorded in depth. Such details can include various parameters such as, but not limited to, types of goods, shop locations, web site URLs, etc., for example.

At the initiation of the service, the requester user can put an agreement upon fee into an escrow, managed through the present system, such that payment is contingent upon the traveler user conducting their carrier services.

The traveler user may complete the carrier service, transporting the specified goods between specified locations. Thereafter, the requester user can confirm the result of the carrier services through a variety of proofs available to the users. Upon confirmation, payment entered into the escrow can be transferred to the traveler user, in this scenario. This may then conclude the carrier services. At the end, the users may be given the options to provide feedback and review for the participating users. The user ranking would be updated based on the review, to further assist future collaborating users.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A matchmaking carrier service system, comprising:
at least one server that is configured to provide a platform that is adapted to receive data from at least one user through at least one user interface so that the at least one user can connect with at least one other user to arrange an agreement for carrier service between at least two locations; and
communication hardware that is communicatively coupled to the at least one server to receive and send data to at least one personal device used by the at least one user to access the platform.

2. The system of claim 1, wherein the at least one user interface includes an automated translation service.

3. The system of claim 1, wherein the at least one user is a requester user.

4. The system of claim 1, wherein the at least one user is a traveler user.

5. The system of claim 1, wherein the carrier service is arranged between at least two users.

6. The system of claim 1, wherein the at least one server includes a remote server or a cloud server.

7. The system of claim 1, wherein the server is adapted to provide an escrow service for payment upon completion of the agreement.

8. A method to provide an online platform for carrier services through peer to peer matchmaking, comprising:
receiving, at a server, data from users for creating user profiles on the online platform where the data is received through at least one user interface;
verifying user profiles through secure methods and frameworks;
posting requests and travel plans on the online platform based on information received from users; and
connecting at least one request user with at least one traveler user to facilitate the arrangement of at least one carrier service between the users.

9. The method of claim 8, wherein the method comprises providing a ranking score for a given user based on information provided about the given user and a history of carrier services completed that involve the given user.

10. The method of claim 8, wherein the method comprises receiving review scores from users for the other users.

11. The method of claim 8, wherein the method comprises securing payment for the carrier service in an escrow, wherein the payment is dispersed to the users upon completion of the carrier service.

12. The method of claim 8, wherein connecting the users further comprises utilizing encryption technologies.

13. A non-transitory computer readable medium storing thereon program instructions, which when executed by at least one processor, configure the at least one processor for performing a method for providing an online platform for carrier services through peer to peer matchmaking, wherein the method is defined according to claim 8.
